(19) United States
(12) Patent Application Publication
(10) Pub. No.: US 2009/0047019 A1
(43) Pub. Date: Feb. 19, 2009

(54) Method and System for Communicating Optical Traffic

(76) Inventors: Paparao Palacharla, Richardson, TX (US); Daniel Bihon, Plano, TX (US); Takao Naito, Plano, TX (US)

Correspondence Address: BAKER BOTTS L.L.P., 2001 ROSS AVENUE, SUITE 600, DALLAS, TX, 75201-2980, US

(21) Appl. No.: 11/838,039

(22) Filed: Aug. 13, 2007

(51) Int. Cl. H04B 10/20; H04J 14/00

(52) U.S. Cl. 398/59

(57) ABSTRACT

A method for communicating optical traffic includes adding optical traffic to an optical ring comprising a plurality of nodes and communicating the optical traffic on the optical ring. The optical traffic comprises a plurality of virtual wavebands which comprise a first virtual waveband of traffic comprising a first number of wavelengths and a second virtual waveband of traffic comprising a second number of wavelengths. The second number is different from the first number. The method also includes dropping the first virtual waveband of traffic at a first node of the plurality of nodes and dropping the second virtual waveband of traffic at a second node of the plurality of nodes.

### TECHNICAL FIELD

The present invention relates generally to optical networks and, more particularly, to a method and system for communicating optical traffic.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of transmitting the signals over long distances with very low loss.

Optical networks often employ wavelength division multiplexing (WDM) or dense wavelength division multiplexing (DWDM) to increase transmission capacity. In WDM and DWDM networks, a number of optical channels are carried in each fiber at disparate wavelengths. Network capacity is based on the number of wavelengths, or channels, in each fiber, the bandwidth, or size, of the channels and the types of nodes utilized in the network.

Continuous wavelengths are typically grouped into bands to simplify node architectures. These groups are called wavebands. Wavebands allow nodes to have two-level multiplexing/demultiplexing structures. At the first level the wavebands are separated, and at the second level the wavelengths within a waveband are separated. Most wavebands include fixed wavelengths and are of equal size.

### SUMMARY

The present invention provides a method and system for communicating optical traffic that substantially eliminates or reduces at least some of the disadvantages and problems associated with previous methods and systems.

In accordance with a particular embodiment, a method for communicating optical traffic includes adding optical traffic to an optical ring comprising a plurality of nodes and communicating the optical traffic on the optical ring. The optical traffic comprises a plurality of virtual wavebands which comprise a first virtual waveband of traffic comprising a first number of wavelengths and a second virtual waveband of traffic comprising a second number of wavelengths. The second number is different from the first number. The method also includes dropping the first virtual waveband of traffic at a first node of the plurality of nodes and dropping the second virtual waveband of traffic at a second node of the plurality of nodes.

The first number of wavelengths of the first virtual waveband of traffic may comprise a plurality of non-contiguous wavelengths, and the second number of wavelengths of the second virtual waveband of traffic may comprise a plurality of non-contiguous wavelengths. The method may further comprise forming the plurality of virtual wavebands by communicating the optical traffic through a tunable band filter and a cyclic arrayed waveguide grating, through a wavelength blocker and a cyclic arrayed waveguide grating, or through a wavelength selective switch.

A system for communicating optical traffic includes an add component coupled to an optical ring and operable to add optical traffic to an optical ring comprising a plurality of nodes. The plurality of nodes are operable to communicate the optical traffic on the optical ring. The optical traffic comprises a plurality of virtual wavebands which comprise a first virtual waveband of traffic comprising a first number of wavelengths and a second virtual waveband of traffic comprising a second number of wavelengths. The second number is different from the first number. The system also includes a first drop component operable to drop the first virtual waveband of traffic at a first node of the plurality of nodes and a second drop component operable to drop the second virtual waveband of traffic at a second node of the plurality of nodes.

Technical advantages of particular embodiments include more efficient use of wavelengths by implementing virtual (as opposed to fixed) wavebands. Virtual wavebands (VWBs) can comprise any suitable number of wavelengths in each waveband, and, in addition, may comprise non-contiguous wavelengths. Such virtual wavebands enable flexible wavelength assignment and can support drop and continue for broadcast traffic. Since each virtual waveband can comprise different numbers of wavelengths, they may be assigned to nodes based on demand at the time. This may reduce blocking and the chance for unused wavelengths.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a block diagram illustrating an optical network, in accordance with a particular embodiment;

FIG. 2 illustrates three sets of wavelengths and their grouping into wavebands, in accordance with a particular embodiment;

FIGS. 3-5 illustrate groupings of virtual wavebands with non-uniform and contiguous wavelengths, in accordance with particular embodiments;

FIG. 6 illustrates a hierarchical ring/mesh network architecture implementing virtual waveband functionality, in accordance with a particular embodiment;

FIGS. 7-9 illustrate example node architectures, in accordance with particular embodiments; and

FIG. 10 illustrates an example connection between a hub node and an access node, in accordance with a particular embodiment.

### DETAILED DESCRIPTION

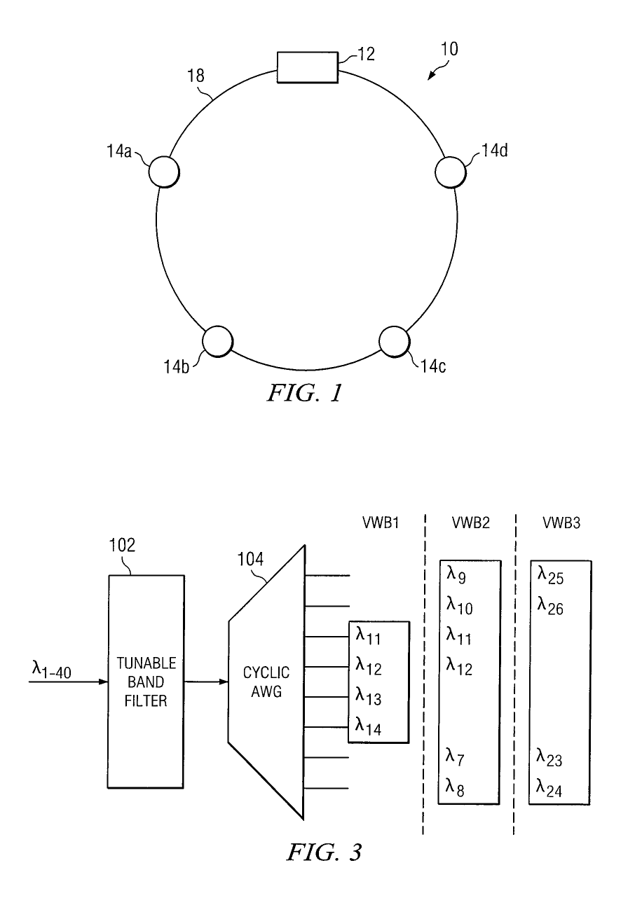

FIG. 1 is a block diagram illustrating an optical network 10, in accordance with a particular embodiment. In accordance with this embodiment, network 10 is an optical ring. An optical ring may include, as appropriate, a single, unidirectional fiber, a single, bi-directional fiber or a plurality of uni- or bi-directional fibers. In the illustrated embodiment, network 10 includes ring 18 which is a pair of unidirectional fibers, each transporting traffic in opposite directions. Ring 18 connects a plurality of nodes 12 and 14. Network 10 is an optical network in which a number of optical channels are carried over a common path in disparate wavelengths/channels. Network 10 may be an wavelength division multiplexing (WDM), dense wavelength division multiplexing (DWDM) or other suitable multi-channel network. Network 10 may be used as a short-haul metropolitan network, a long-haul inter-city network or any other suitable network or combination of networks. In the illustrated embodiment, node 12 is a hub node that distributes traffic to and receives traffic from client nodes 14. Traffic may be dropped and added to the network at client nodes 14. While four nodes are illustrated in network 10, network 10 may include fewer or greater than four nodes in other embodiments and such nodes may comprise any combination of client nodes, hub nodes or other types of nodes. In addition, other embodiments may include networks of various node architectures, such as the hub and spoke architecture of FIG. 1 and hierarchical ring/mesh architectures.

In conventional networks, client nodes may each be assigned one or more wavebands (WBs) to use for traffic added and dropped at that particular node. Each waveband typically consists of an equal number of contiguous wavelengths. For example, traffic communicated on network 10 may include 6 wavebands each comprising 4 wavelengths. For example, the first waveband may comprise wavelengths λ₁-λ₄, the second waveband may comprise wavelengths λ₅-λ₈, the third waveband may comprise wavelengths λ₉-λ₁₂, the fourth waveband may comprise wavelengths λ₁₃-λ₁₆, the fifth waveband may comprise wavelengths λ₁₇-λ₂₀, and the sixth waveband may comprise wavelengths λ₂₁-λ₂₄. Each node may be assigned one or more separate wavebands. For example, node 14a might be assigned the first waveband (e.g., to use λ₁-λ₄) for its traffic, node 14b may be assigned the second and third wavebands, node 14c may be assigned the fourth and fifth wavebands and node 14d may be assigned the sixth waveband. Such assignments may be made based on estimated traffic demand (e.g., it may be estimated that nodes 14b and 14c will need more wavelength capacity than nodes 14a and 14d in the above example assignments).

However, the conventional approach described above may be inefficient. For example, while node 14a may be assigned one waveband comprising four wavelengths, its demand may be such that it only needs two wavelengths thereby leaving two wavelengths unused. If, for example, node 14c needed more than the eight wavelengths assigned, it would not be possible for it to simply use the unused wavelengths assigned to node 14a. Thus, depending on traffic distribution, this fixed waveband approach can lead to blocking under small network loads. In addition, drop and continue for broadcast is not easily supported (e.g., λ₁ may only be in one waveband and may thus not be accessible at other nodes).

Particular embodiments provide more efficient use of wavelengths by implementing virtual (as opposed to fixed) wavebands. Virtual wavebands (VBs) can comprise any suitable number of wavelengths in each waveband, and, in addition, may comprise non-contiguous wavelengths (instead of a waveband having λ₁-λ₄, it may comprise, for example, λ₁, λ₃, λ₇ and λ₈). Such virtual wavebands enable flexible wavelength assignment and can support drop and continue for broadcast traffic. Since each virtual waveband can comprise different numbers of wavelengths, they may be assigned to nodes based on demand at the time. For example, if there are 24 total wavelengths available, node 14a may be assigned a waveband with two wavelengths, node 14b may be assigned a waveband with nine wavelengths, node 14c may be assigned a waveband with eight wavelengths and node 14d may be assigned a waveband with seven wavelengths. This may reduce blocking and the chance for unused wavelengths.

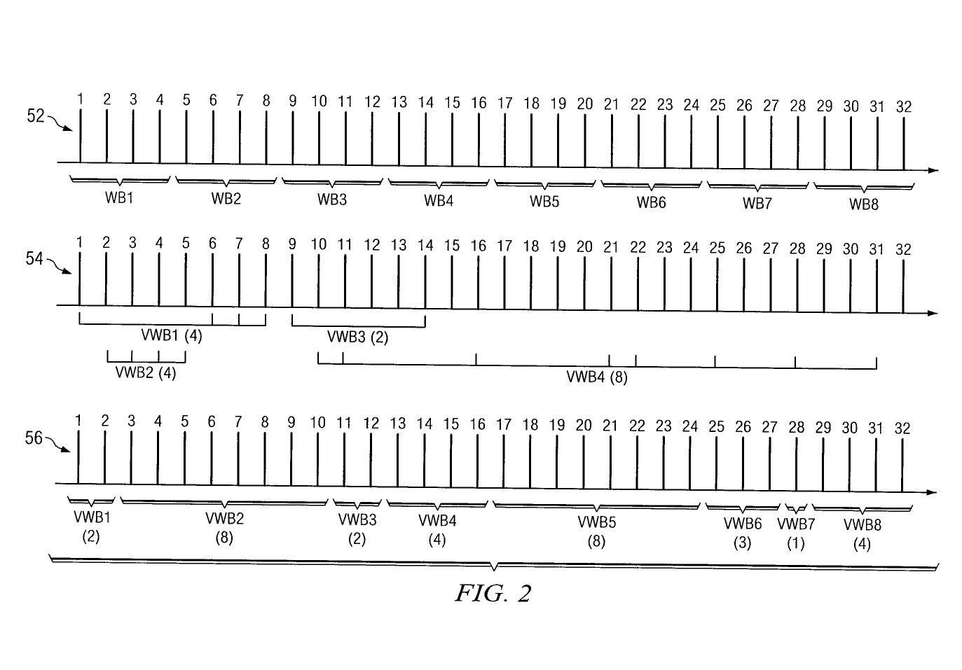

FIG. 2 illustrates three sets of wavelengths and their grouping into wavebands. Set 52 shows thirty-two wavelengths, some of which are each grouped into a particular waveband. Each waveband (WB1-WB8) comprises four, contiguous wavelengths. Set 54 illustrates the composition of virtual wavebands in accordance with a particular embodiment.

In set 54, there are four virtual wavebands (VWB1-VWB4). VWB1 includes four wavelengths—λ₁, λ₆, λ₇ and λ₈. VWB2 includes four wavelengths—λ₂-λ₅. VWB3 includes two wavelengths—λ₉ and λ₁₄. VWB4 includes eight wavelengths—λ₁₀, λ₁₁, λ₁₆, λ₂₁, λ₂₂, λ₂₅, λ₂₈ and λ₃₁. Thus, set 54 includes virtual wavebands having non-uniform and non-contiguous wavelength composition. In addition, as evident, fourteen of the thirty-two available wavelengths are not currently grouped into a virtual waveband.

Set 56 shows eight virtual wavebands (VWB1-VWB8). VWB1 includes two wavelengths—λ₁-λ₂. VWB2 includes eight wavelengths—λ₃-λ₁₀. VWB3 includes two wavelengths—λ₁₁-λ₁₂. VWB4 includes four wavelengths—λ₁₃-λ₁₆. VWB5 includes eight wavelengths—λ₁₇-λ₂₄. VWB6 includes three wavelengths—λ₂₅-λ₂₇. VWB7 includes one wavelength—X₂₈. VWB8 includes four wavelengths—λ₂₉-λ₃₂. Thus, set 56 includes virtual wavebands having non-uniform and contiguous wavelength composition.

While two sets are virtual wavebands are illustrated with certain compositions, particular embodiments may implement for a network or portion of a network any suitable number of combination of virtual wavebands each having any suitable number and contiguous or non-contiguous distribution of wavelengths.

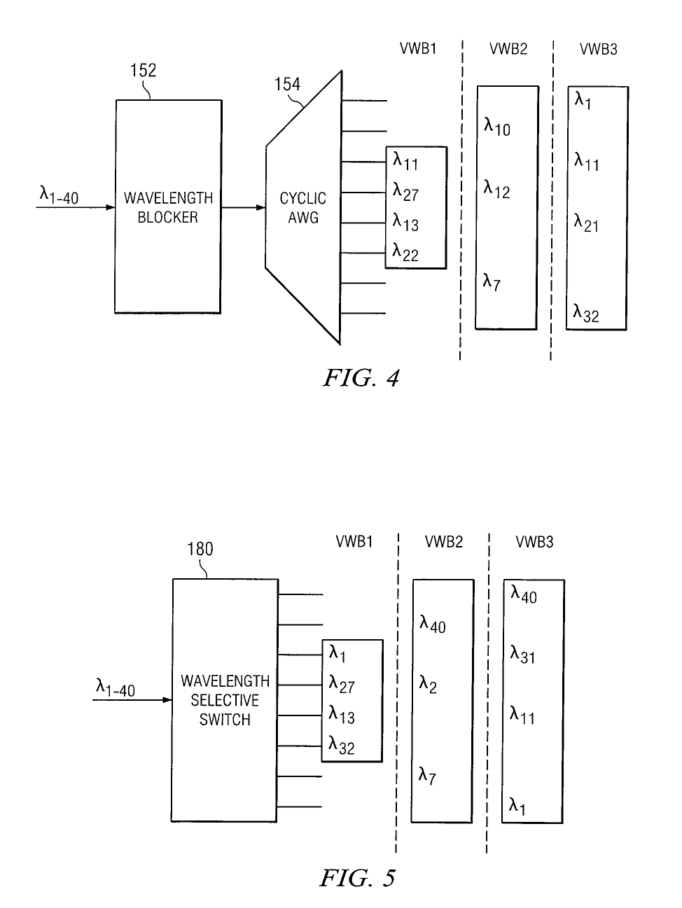

FIGS. 3-5 illustrate various example ways to implement virtual wavebands in an optical network, in accordance with particular embodiments. FIG. 3 shows the grouping of three virtual wavebands with non-uniform and contiguous wavelengths. Wavelengths λ₁-λ₄₀ enter a tunable band filter 102. Tunable band filter 102 selects different bandwidths at different times—it can change both the center frequency and bandwidth size in order to select bandwidths. The traffic then continues to a cyclic arrayed waveguide grating (AWG) demultiplexer 104, or a m-skip-0 AWG demultiplexer as it may be called in some embodiments. The cyclic AWG demultiplexer can group continuous wavelengths into virtual wavebands. Depending on how it is set and/or configured, cyclic AWG demultiplexer 104 may group non-uniform virtual wavebands (or virtual wavebands having different numbers of wavelengths). As can be seen in this example, tunable band filter 102 and cyclic AWG demultiplexer 104 group VWB1 comprising four contiguous wavelengths (λ₁₁-λ₁₄), VWB2 comprising six contiguous wavelengths (λ₇-λ₁₂) and VWB3 comprising four contiguous wavelengths (λ₂₃-λ₂₆). These three virtual wavebands can be used to carry traffic for use by and distribution at one or more nodes.

FIG. 4 shows the grouping of three virtual wavebands with non-uniform and non-contiguous wavelengths. Wavelengths λ₁-λ₄₀ enter a wavelength blocker 152. Wavelength blocker 152 may be set and/or configured to block or allow any particular wavelengths entering the blocker. The wavelength blocker enables the grouping of non-uniform and non-contiguous wavelengths when working together with cyclic AWG demultiplexer 154. As can be seen in this example, wavelength blocker 152 and cyclic AWG demultiplexer 154 group VWB1 comprising four non-contiguous wavelengths (λ₁₁, λ₁₃, λ₂₂ and λ₂₇), VWB2 comprising three non-contiguous wavelengths (λ₇, λ₁₀ and λ₁₂) and VWB3 comprising four non-contiguous wavelengths (λ₁, λ₁₁₁, λ₂₁ and λ₃₂). These three virtual wavebands can be used to carry traffic for use by and distribution at one or more nodes.

FIG. 5 shows the grouping of three virtual wavebands with non-uniform and non-contiguous wavelengths. Wavelengths λ₁-λ₄₀ enter a wavelength selective switch (WSS) 180. WSS 180 can be set and/or configured to block or allow any wavelength on each of its output ports. It places no constraints on the wavelength-to-port mapping, and WSSs in some embodiments may support broadcast and multicast of wavelengths. As can be seen in this example, WSS 180 group VWB1 comprising four non-contiguous wavelengths (λ₁, λ₁₃, λ₂₇ and λ₃₂), VWB2 comprising three non-contiguous wavelengths (λ₂, λ₇ and λ₄₀) and VWB3 comprising four non-contiguous wavelengths (λ₁, λ₁₁, λ₃₁ and λ₄₀). These three virtual wavebands can be used to carry traffic for use by and distribution at one or more nodes.

FIGS. 3-5 represent three examples of grouping wavelengths into virtual wavebands according to some embodiments, and other embodiments may utilize the same, similar or different components to implement virtual waveband functionality within a network or a portion of a network.

The various examples disclosed herein for virtual wavebands may be implemented at the nodes in any suitable manner. In some examples the steering and grooming of wavelengths may be done at a gateway or hub node, external to a distribution node, by implementing the filtering or blocking at the gateway or hub node. In such case, the distribution node may a wavelength blocker between a cyclic AWG for dropping traffic and either a coupler or cyclic AWG for adding traffic at the node. Cyclic components enable a single card solution to cover the full C-band. The wavelength blocker enables wavelength reuse at the node. In other examples, the filtering or blocking may be performed at the distribution node, for example, just before the drop side cyclic AWG. As another example, 1×N WSSs may be used for both the drop side and add side at the node. This provides a colorless, fully flexible solution that is higher cost but lower density.

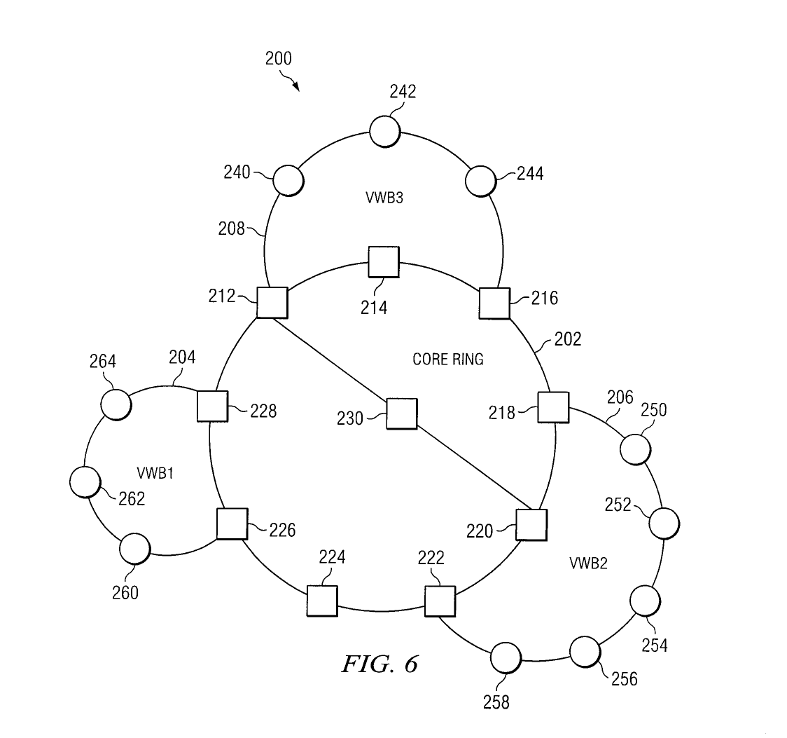

FIG. 6 illustrates a hierarchical ring/mesh network architecture implementing virtual waveband functionality, in accordance with a particular embodiment. Network architecture 200 includes a core ring 202 and distribution rings 204, 206 and 208. Core ring 202 includes nodes 212, 214, 216, 218, 220, 222, 224, 226, 228 and 230. One or more of these nodes may be gateway nodes to steer and/or groom virtual wavebands to the distribution rings. For example, nodes 212 and 216 may be gateway nodes that steer traffic to and/or from distribution ring 208, nodes 218 and 222 may be gateway nodes that steer traffic to and/or from distribution ring 206 and nodes 226 and 228 may be gateway nodes that steer traffic to and/or from distribution ring 204.

Distribution ring 208 includes distribution nodes 240, 242 and 244, distribution ring 206 includes distribution nodes 250, 252, 254, 256 and 258 and distribution ring 208 includes distribution nodes 260, 262 and 264. Implementing virtual wavebands in network architecture 200 allows for the distribution of the correctly-sized bandwidth to each distribution ring. In addition, the sizes of the distributed bandwidths can be changed according to network usage and needs thus enabling flexible wavelength assignment. In addition, network architecture 200 can support drop and continue or broadcast traffic implementations.

As discussed above, implementing virtual wavebands allows for any suitable number of consecutive or nonconsecutive wavelengths to be grouped together in any suitable number of virtual wavebands for distribution to distribution rings 204, 206 and 208 and to distribution nodes 240, 242, 244, 250, 252, 254, 256, 258, 260, 262 and 264. Nodes illustrated herein may include any suitable add and/or drop components, such as couplers, WSSs, AWGs or other optical components, for adding and/or dropping traffic to and from optical rings.

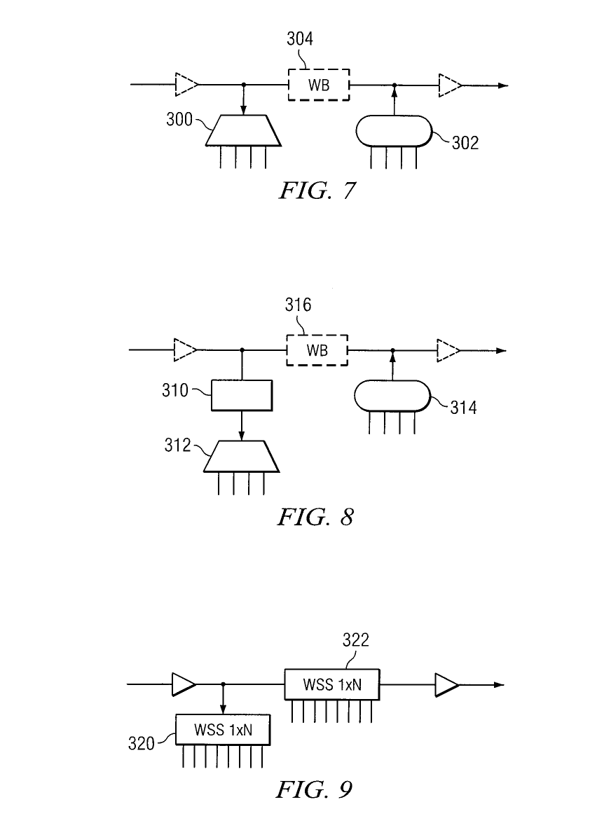

FIGS. 7-9 illustrate example node architectures in accordance with particular embodiments. FIG. 7 includes a node architecture with a cyclic AWG 300 for the distribution of traffic at the node, and a coupler 302 for the addition of traffic at the node. A wavelength blocker 304 may be used to enable re-use of wavelengths. In this configuration, the steering and grooming of wavelengths to the node is performed externally to this node. For example, the filtering and/or blocking functions may be performed at a gateway or hub node. Thus, this configuration may be suitable for a node on a distribution ring.

FIG. 8 includes a node architecture with a filter or blocker 310 and a cyclic AWG 312 for the distribution of traffic at the node, and a coupler 314 for the addition of traffic at the node. The use of the filter/blocker enables for the steering and grooming of virtual wavebands at the node. A wavelength blocker 316 may be used to enable re-use of wavelengths.

The node architectures of FIGS. 7 and 8, using a cyclic AWG for the drop side and a coupler (or, alternatively, a cyclic AWG) for the add side provides a low cost and high density architecture. In addition, illustrated optical amplifiers may be optional based on span losses.

FIG. 9 includes a node architecture with 1×N WSSs 320 and 322 for the drop side and the add side, respectively, of the node. This provides a simple, fully flexible, high cost and low density solution that allows for steering and grooming of any number of wavelengths into virtual wavebands at the node.

FIGS. 7-9 represent three examples of node architectures implementing virtual waveband functionality according to some embodiments, and other embodiments may utilize the same, similar or different components to implement virtual waveband functionality within a network or a portion of a network.

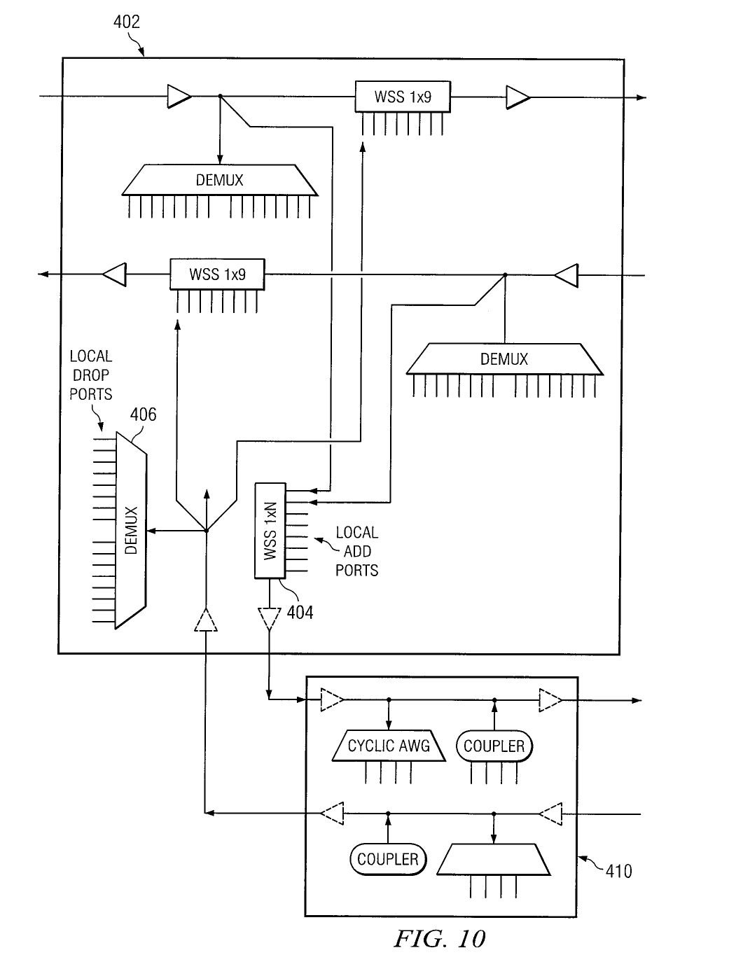

FIG. 10 illustrates an example connection between a hub node and an access node, in accordance with a particular embodiment. FIG. 10 includes a hub node 402 with traffic flowing on two rings in opposite directions through the node. In particular, hub node 402 includes a 1×N WSS 404 to steer and groom wavelengths into virtual wavebands for distribution to access node 410 or other distribution rings. As illustrated, WSS 404 includes ports for locally added traffic. Hub node 402 also includes a demultiplexer for local drop ports.

In particular embodiments, a third degree arm of the hub node can be optimized. For example, if the hub node acts as a pass-through node (e.g., with no local add or drop traffic), demultiplexer 406 may be eliminated or the WSS may be changed to a blocker.

Although the present invention has been described in detail with reference to particular embodiments, it should be understood that various other changes, substitutions, and alterations may be made hereto without departing from the spirit and scope of the present invention. For example, although particular embodiments have been described with reference to a number of ring and node architectures and various components for implementing virtual wavebands, these architectures and components may be combined, rearranged or positioned in order to accommodate particular routing architectures or needs. Particular embodiments contemplate great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

What is claimed is:

1. A method for communicating optical traffic, comprising:
adding optical traffic to an optical ring comprising a plurality of nodes;
communicating the optical traffic on the optical ring, the optical traffic comprising a plurality of virtual wavebands comprising:
a first virtual waveband of traffic comprising a first number of wavelengths; and
a second virtual waveband of traffic comprising a second number of wavelengths, the second number different from the first number;
dropping the first virtual waveband of traffic at a first node of the plurality of nodes; and
dropping the second virtual waveband of traffic at a second node of the plurality of nodes.

2. The method of claim 1, wherein the first number of wavelengths of the first virtual waveband of traffic comprise a plurality of non-contiguous wavelengths.

3. The method of claim 2, wherein the second number of wavelengths of the second virtual waveband of traffic comprise a plurality of non-contiguous wavelengths.

4. The method of claim 1, further comprising forming the plurality of virtual wavebands by communicating the optical traffic through a tunable band filter and a cyclic arrayed waveguide grating.

5. The method of claim 1, further comprising forming the plurality of virtual wavebands by communicating the optical traffic through a wavelength blocker and a cyclic arrayed waveguide grating.

6. The method of claim 1, further comprising forming the plurality of virtual wavebands by communicating the optical traffic through a wavelength selective switch.

7. A system for communicating optical traffic, comprising:
an add component coupled to an optical ring and operable to add optical traffic to an optical ring comprising a plurality of nodes;
the plurality of nodes operable to communicate the optical traffic on the optical ring, the optical traffic comprising a plurality of virtual wavebands comprising:
a first virtual waveband of traffic comprising a first number of wavelengths; and
a second virtual waveband of traffic comprising a second number of wavelengths, the second number different from the first number;
a first drop component operable to drop the first virtual waveband of traffic at a first node of the plurality of nodes; and
a second drop component operable to drop the second virtual waveband of traffic at a second node of the plurality of nodes.

8. The system of claim 7, wherein the first number of wavelengths of the first virtual waveband of traffic comprise a plurality of non-contiguous wavelengths.

9. The system of claim 8, wherein the second number of wavelengths of the second virtual waveband of traffic comprise a plurality of non-contiguous wavelengths.

10. The system of claim 7, further comprising a tunable band filter and a cyclic arrayed waveguide grating operable to form the plurality of virtual wavebands.

11. The system of claim 7, further comprising a wavelength blocker and a cyclic arrayed waveguide grating operable to form the plurality of virtual wavebands.

12. The system of claim 7, further comprising a wavelength selective switch operable to form the plurality of virtual wavebands.

13. A system for communicating optical traffic, comprising:
means for adding optical traffic to an optical ring comprising a plurality of nodes;
means for communicating the optical traffic on the optical ring, the optical traffic comprising a plurality of virtual wavebands comprising:
a first virtual waveband of traffic comprising a first number of wavelengths; and
a second virtual waveband of traffic comprising a second number of wavelengths, the second number different from the first number;
means for dropping the first virtual waveband of traffic at a first node of the plurality of nodes; and
means for dropping the second virtual waveband of traffic at a second node of the plurality of nodes.

14. A method for communicating optical traffic, comprising:
communicating optical traffic on a plurality of optical rings coupled together, the plurality of optical rings comprising a core ring, a first distribution ring, and a second distribution ring, each of the plurality of optical rings comprising a plurality of optical nodes;
distributing at a first optical node of the core ring a first virtual waveband of traffic communicated on the core ring to the first distribution ring, the first virtual waveband of traffic comprising a first number of wavelengths; and
distributing at a second optical node of the core ring a second virtual waveband of traffic communicated on the core ring to the second distribution ring, the second virtual waveband of traffic comprising a second number of wavelengths, the second number different from the first number.

15. The method of claim 14, wherein the first number of wavelengths of the first virtual waveband of traffic comprise a plurality of non-contiguous wavelengths.

16. The method of claim 15, wherein the second number of wavelengths of the second virtual waveband of traffic comprise a plurality of non-contiguous wavelengths.

17. A system for communicating optical traffic, comprising:
a plurality of optical rings coupled together and operable to communicate optical traffic, the plurality of optical rings comprising a core ring, a first distribution ring, and a second distribution ring, each of the plurality of optical rings comprising a plurality of optical nodes;
a first optical node of the core ring operable to distribute a first virtual waveband of traffic communicated on the core ring to the first distribution ring, the first virtual waveband of traffic comprising a first number of wavelengths; and
a second optical node of the core ring operable to distribute a second virtual waveband of traffic communicated on the core ring to the second distribution ring, the second virtual waveband of traffic comprising a second number of wavelengths, the second number different from the first number.

18. The system of claim 17, wherein the first number of wavelengths of the first virtual waveband of traffic comprise a plurality of non-contiguous wavelengths.

19. The system of claim 18, wherein the second number of wavelengths of the second virtual waveband of traffic comprise a plurality of non-contiguous wavelengths.
